(19) United States
(12) Patent Application Publication
(10) Pub. No.: US 2015/0040515 A1
(43) Pub. Date: Feb. 12, 2015

(54) LABELLING MACHINE

(71) Applicant: Sidel S.p.A con SOCIO UNICO, Parma (IT)

(72) Inventors: Stefano Molinari, Parma (IT); Godet Florian, Parma (IT)

(73) Assignee: Sidel S.p.A. con SOCIO UNICO, Parma (IT)

(21) Appl. No.: 14/386,372

(22) PCT Filed: Mar. 20, 2013
(86) PCT No.: PCT/EP2013/055861

§ 371 Date: Sep. 19, 2014

(30) Foreign Application Priority Data
Mar. 20, 2012 (IT) TO2012A000251

(51) Int. Cl. B65C 9/04; B67C 3/24; B65C 3/16; B67C 3/04

(52) U.S. Cl. CPC B65C 9/04; B67C 3/045; B67C 3/24; B65C 3/16; B67C 2003/226
USPC 53/127; 156/556; 156/378

(57) ABSTRACT

A labelling machine for applying labels on respective containers is disclosed. The labelling machine is provided with at least one operative unit, adapted to receive a relative container to be labelled and having a support element for supporting a base portion of the container, with a conveyor device for transferring the operative unit from a feeding station of the containers to an outlet station, and with feeding means for providing at least one label to be applied on the container borne by the operative unit The operative unit also comprises an actuator element borne by the conveyor device on the opposite side of the support element with respect to the receiving position of the container.

### TECHNICAL FIELD

The present invention relates to a labelling machine for applying labels on respective containers, in particular containers made of plastic, such as for example bottles.

The present invention is advantageously but not exclusively applicable in the sector of plastic hot fill containers, to which the following description will explicitly refer without because of this loosing in generality and without any reference being intended as a limitation to the protection scope defined by the appended claims.

### BACKGROUND ART

As is known, the containers of the above mentioned type, after having been filled with hot—for example at about 85° C.—pourable products or liquids, are first subjected to a capping operation and then cooled so as to return to a room temperature. By effect of the capping operation, the heated air present in the top portion (designated “head space”) of the container expands causing a stress tending to produce a general swelling of the container at the side wall and at the base wall. The following cooling to which the container is subjected, causes, vice versa, a reduction of the volume of air and minimally of the liquid product contained in the container; a depression is therefore created, which tends to pull the side walls and the base wall of the container inwards. This may determine deformations in the walls of the container if these are not rigid enough to resist the action of the above disclosed stresses.

In order to contain the depressive stresses generated during the cooling of the product within the containers without generating undesired deformations on the containers, the latter are typically provided, at the side wall, with a series of vertical panels, commonly designated “vacuum panels”. These panels, in the presence of depressive stresses, are deformed inwardly of the container allowing it to resist to the hot fill process without generating undesired deformations in other areas of the container.

Likewise, the known containers intended to be subjected to a hot fill process can also have an optimised lower portion or base portion adapted to be deformed upwards under the action of the depressive stresses.

Even though the disclosed solutions allow to “relieve” the pressure stresses on specific parts of the containers, i.e. the vertical vacuum panels or the base portion, thus avoiding the occurrence of undesired deformations in other parts of the containers, they do not allow the cancellation of the above said stresses; in other words, the containers remain in any case subject to internal depressive stresses and must therefore be provided with a structure capable of resisting such stresses.

Patent application WO2006/068511 shows a container having a deformable base portion, which can take two different configurations: a first unstable configuration, in which this portion has a central area projecting downwards with respect to the outermost annular area immediately adjacent thereto, and a second stable configuration, in which the central area is retracted inwardly of the container, i.e. is arranged in a higher position with respect to the adjacent annular area.

Following the filling with the hot pourable product, the base portion of the container takes the first unstable configuration and must be supported by a special cup element to which it is coupled. Thereby, the downward deformation of the base portion of the container can be maximised without compromising the stable support of the container, since such a support is accomplished by the cup element. Following the cooling, the base portion can be displaced by an external action, for example a vertical thrust upwards, in the second stable configuration with the subsequent possibility of removing the cup element.

The displacement of the base portion of the container from the first to the second configuration determines a considerable reduction of the containment volume of the container, much higher than would be obtained in the known containers simply by the deformation of the base portion by the effect of the sole depressive stresses; the final effect is therefore substantially the cancellation of the depressive stresses acting on the inside of the container.

On the basis of the above said, the disclosed containers must be subjected to the following operations to achieve their final shape:
a filling operation with the hot pourable product on a filling machine;
a subsequent operation of capping on a capping machine;
a cooling operation in an appropriate station;
an inversion operation on a relative processing machine, in which the base portions of the containers are mechanically displaced from the first to the second configuration;
a labelling operation on a relative labelling machine; and
possible further finishing operations if required.

As is known, the filling machines, the capping machines and the labelling machines are generally rotating machines, in which the containers are fed on respective carousels. In particular, each carousel is provided with a plurality of operative units for receiving and processing the containers, uniformly distributed about the rotation axis of the carousel; more precisely, each operative unit is commonly provided with an element for supporting the relative container which maintains it in a predetermined position for carrying out the specific operation/s.

As can be easily noted, the process for the production of the above said finished containers is rather time-consuming and requires considerable room within the relative plants; in order to carry out the different operations indicated, it is necessary to provide a relatively high number of machines and conveyors adapted to transfer the containers from a machine to another.

### DISCLOSURE OF INVENTION

It is an object of the present invention to therefore find a simple and cost-effective solution to solve the above said drawback, i.e. reduce the number of machines required to perform the sequence of disclosed operations and subsequently the number of conveyors required to transfer the containers from one machine to another.

The abovementioned object is achieved by the present invention because it relates to a labelling machine as defined in claim 1.

The present invention further relates to a processing plant for containers as defined in claim 13.

### BRIEF DESCRIPTION OF THE DRAWINGS

A preferred embodiment is hereinafter disclosed for a better understanding of the present invention, by mere way of non-limitative example and with reference to the accompanying drawings, in which:

FIG. 1 shows a diagrammatic plan view with parts removed for clarity of a labelling machine according to the dictates of the present invention;

FIG. 2 is a partial sectional side view, on an enlarged scale, of an operative unit of the labelling machine of FIG. 1, in a first configuration;

FIG. 3 is a partial sectional side view, on an enlarged scale, of an operative unit of FIG. 2, in a second configuration;

FIG. 4 is a partial sectional side view, on an enlarged scale, of a possible variant of the operative unit of FIGS. 2 and 3, in a first configuration;

FIG. 5 is a partial sectional side view, on an enlarged scale, of an operative unit of FIG. 4, in a second configuration; and

FIG. 6 is a diagrammatic plan view of a processing plant for containers including the labelling machine of FIG. 1.

### BEST MODE FOR CARRYING OUT THE INVENTION

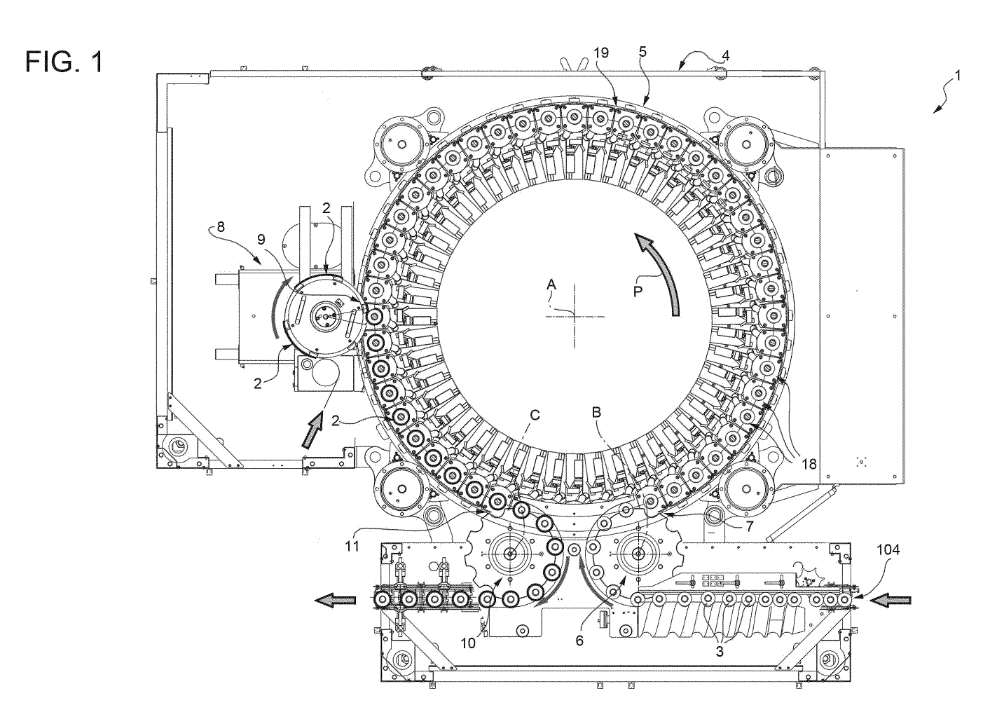

With reference to FIG. 1, numeral 1 indicates as a whole a labelling machine for applying labels 2 on respective containers, in particular plastic bottles 3.

Machine 1 essentially comprises a support structure 4 (only partially visible in FIG. 1) and a carousel 5 mounted on support structure 4 rotatably about a vertical central axis A.

Carousel 5 receives a sequence of bottles 3 to be labelled by an inlet star wheel 6, which cooperates with carousel 5 at a first transfer station 7 and is mounted to rotate about a respective longitudinal axis B parallel to axis A.

Carousel 5 also receives a sequence of rectangular or square labels 2 from a labelling unit 8 (known per se and only diagrammatically shown), which cooperates with carousel 5 at a second transfer station 9.

Carousel 5 releases a sequence of labelled bottles 3 to an outlet star wheel 10, which cooperates with carousel 5 at a third transfer station 11 and is mounted to rotate about a respective longitudinal axis C parallel to axes A and B.

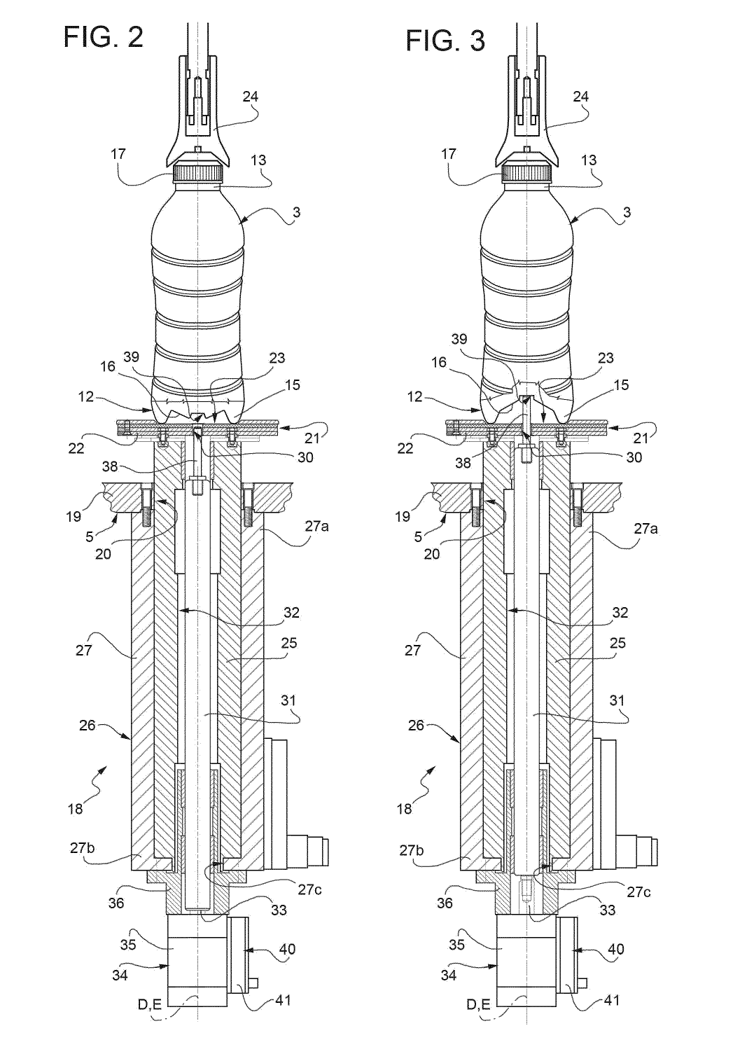

As may be seen in detail in FIGS. 2 and 3, each bottle 3 has a longitudinal axis D, is limited on the bottom by a base portion 12 and ends on top with a neck 13 defining an opening (not visible) for pouring the product contained in bottle 3.

In the case shown, base portion 12 has an annular area 15 having axis D, radially external and defining a resting surface of relative bottle 3, and a central area 16, surrounded by annular area 15 and arranged normally higher along axis D with respect to annular area 15; in particular, central area 16 is arranged at a distance from neck 13 along axis D smaller than the distance between neck 13 and annular area 15.

Base portion 12 is deformable and can take two different configurations, shown in FIGS. 2 and 3. In the first configuration (FIG. 2), central area 16 of base portion 12 is deformed and swollen downwards, i.e. is arranged at a maximum distance from neck 13 along axis D; in the second configuration (FIG. 3), central area is instead retracted inwardly of relative bottle 3, i.e. is arranged at a smaller distance along axis D from neck 13 with respect to the first configuration. It is apparent that bottles 2 have, in the second configuration of base portion 12, a containing volume smaller with respect to that in the first configuration.

Bottles 2 are fed to carousel 5 in a condition in which they have been filled with the pourable product, normally a liquid food product, and closed, at neck 13, with a relative closing device or cap 17.

In the case shown, bottles 3 are fed to carousel 5 after having been hot filled and subjected to a cooling operation. Base portion 12 is therefore arranged in the first configuration, i.e. is deformed and swollen downwards, and within bottle 3 there are depressive stresses which tend to displace base portion 12 towards the second configuration.

Bottles 3 reach carousel 5 in a vertical position, i.e. with base portion 12 arranged on the bottom with respect to neck 13 and to cap 17 and with axis D parallel to axes A, B and C.

Carousel 5 comprises a plurality of operative units 18 (only one of which shown in detail in FIGS. 2 and 3), which are uniformly distributed about axis A and are mounted at a peripheral portion of carousel 5.

Operative units 18 are displaced by carousel 5 along a circular path P which extends about axis A and through transfer stations 7, 9 and 11. In particular, considering path P (FIG. 1), transfer station 7, in which bottles 3 are fed to carousel 5, is arranged upstream of transfer station 9 for feeding labels 2, and latter station 9 is clearly arranged upstream of transfer station 11, in which labelled bottles 3 are fed to outlet wheel 10.

As may be seen in FIGS. 2 and 3, operative units 18 are fixed to a horizontal rotating table 19 of carousel 5, have respective axes E parallel to axes A, B, C and orthogonal to path P, and extend coaxially through respective through-holes 20 of rotating table 19 and on both sides thereof.

Each operative unit 18 is adapted to receive a relative bottle 3 in a vertical position, i.e. having its axis D coaxial to relative axis E, and to retain this bottle 3 in the above said position along path P from transfer station 7 to transfer station 11.

Since operative units 18 are identical to one another, only one will be disclosed in detail hereinafter for clarity and simplicity; it is clear that the features that will hereinafter disclosed are common to all operative units 18.

In particular, operative unit 18 comprises, above rotating table 19, a support element 21 adapted to define a horizontal support for base portion 12 of a relative bottle 3. In particular, support element 21 comprises a plate 22 extending orthogonally to axis E and having, on top, a central area 23 which is hollowed with respect to the outermost part of plate 22 and is adapted to support base portion 12 of relative bottle 3. In practice, annular area 15 which is the outermost of base portion 12 of bottle 3 is totally engaged within hollowed central area 23 of relative plate 22 so that bottle 3 is maintained stably in the vertical position; hollowed central area 23 of plate 22 therefore defines a receiving and housing seat for base portion 12 of relative bottle 3.

As can be seen in FIGS. 2 and 3, each bottle 3, when housed on relative operative unit 18, is also locked on top by a retaining member 24 cooperating with cap 17 of bottle 3.

Support element 21 is also fixed to a rotating member 2 of a relative electric motor 26, so as to be rotated about axis E when relative bottle 3 receives a label 2 from labelling unit 8.

In particular, electric motor 26 comprises a hollow cylindrical stator 27, protrudingly fixed to the lower side of rotating table 19 about hole 20 and coaxially thereto; more precisely, stator 27 has a top end 27a fixed to a lower face of rotating table 19 and protrudes on the lower side of rotating table 19.

Rotating member 25, also cylindrical and hollow, is mounted for the most part within stator 27 and projects on top therefrom so as to engage coaxially and pass through hole 20 of rotating table 19 of carousel 5. Rotating member 25 is mounted rotatingly about axis E with respect to stator 27 and to rotating table 19; in other words, rotating member 19 rotatingly engages hole 20 of rotating table 19.

Support element 21 finally protrudes from the top of rotating member 25.

Advantageously, plate 22 of support element 21 has a through-opening coaxial to axis E, and operative unit 18 also comprises an actuator element 31, borne by rotating table 19 of carousel 5 on the opposite side of support element 21 with respect to bottle 3, which is selectively displaceable along axis E, with respect to support element 21, to act, through opening 30, on base portion 12 of relative bottle 3 and displace it from the first to the second configuration.

In particular, actuator element 31 preferably has a cylindrical configuration, axially and slidingly engages a central through-hole 32 having axis E of rotating member 25 and is selectively displaceable between a resting position, in which it is spaced from base portion 12 of bottle 3 borne by support element 21, and an operative position, in which it engages opening 30 of support element 21 and cooperates with base portion 12 of bottle 3 to bring it from the first to the second configuration.

Preferably, actuator element 31 is coupled to a piston 33 of a fluidic actuator assembly 34, for example of the pneumatic type.

According to a possible variant which is not shown, actuator element 31 could also be entirely defined by the piston of actuator assembly 34.

According to another possible variant (not shown), actuator element 31 could be coupled to, or be defined, by a linear motion mobile member.

According to another possible variant (not shown), actuator element 31 could be driven by an electric motor coupled with a worm screw.

Actuator assembly 34 is arranged on the opposite side of electric motor 26 with respect to support element 21.

In the case shown, actuator assembly 34 comprises an outer housing 35 which protrudes by means of a flanged sleeve 36 to a lower end 27b of stator 27, opposite to end 27a and provided with a through hole 27c.

Piston 33 is partially engaged in a sliding manner along axis E in housing 35 and projects on top therefrom with an end portion coupled to actuator element 31.

As may be seen in FIGS. 2 and 3, actuator element 31 engages hole 27c of end 27b of stator 27 in a sliding manner and ends on top with a small rod 38 which interacts with a relative central notch 39 obtained in base portion 12 of relative bottle 3. In the example shown, small rod 38 has a reduced diameter with respect to the remaining part of actuator element 31.

Small rod 38 could have any configuration and in particular may be parameterised with the format of bottle 3 to be processed.

In brief, in the disclosed configuration of operative unit 18, stator 27, rotating member 25, support element 21, actuator assembly 34 and actuator element 31 move with rotating table 19 about axis A; in addition to this movement, rotating member 25 can rotate about axis E with support element 21 with respect to the other components of operative unit 18; finally, actuator element 31 and piston 33 can translate along axis E with respect to the other components of operative unit 18.

Preferably, operative unit 18 also comprises sensor means 40 adapted to detect the displacement along axis E performed by actuator element 31 to bring base portion 12 of relative bottle 3 from the first configuration to the second configuration.

In the case shown, sensor means 40 comprise a position transducer 41 (known per se) adapted to detect the position of piston 33 during its movements; in practice, position transducer 41 generates an outlet signal correlated to the position taken by piston 33. On the basis of the position of piston 33 before and at the end of the interaction stroke with base portion 12 of relative bottle 3, the extent of the displacement of piston 33 and therefore of actuator element 31 can be determined. By monitoring the displacement of actuator element 31 during every action on bottles 3, it is possible to detect by how much this measured displacement differs from a range of desired values; this measure allows to indirectly perform a quality control of bottle 3.

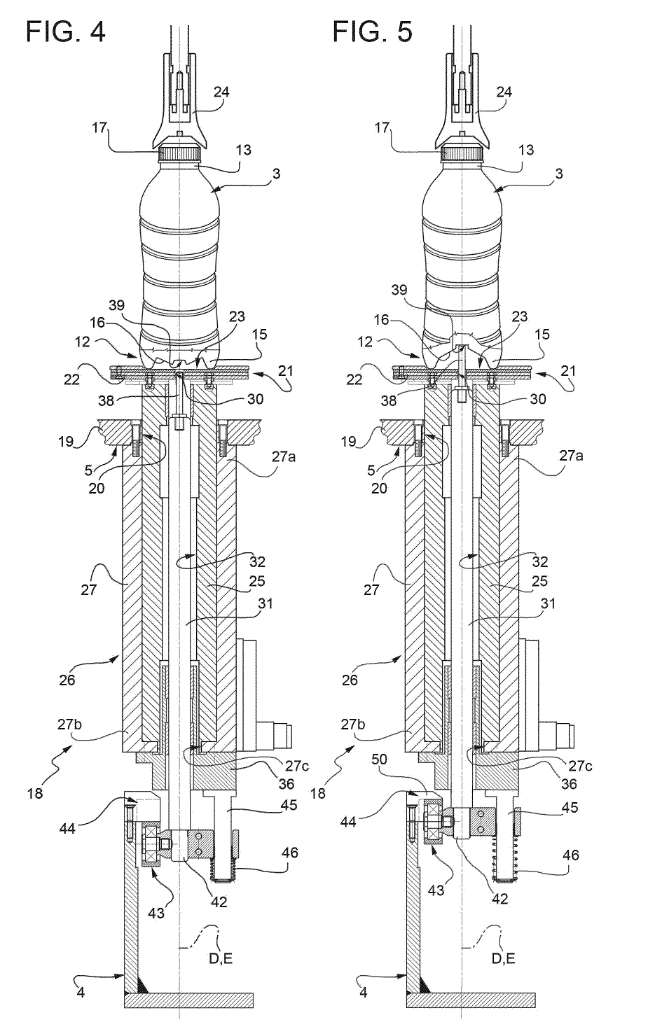

In FIGS. 4 and 5, a possible variant is shown of the displacement system of actuator element 31 of each operative unit 18. In this case, each actuator element 31 is provided, at a lower end 42 thereof, opposite to small rod 39, with a cam follower roller 43 adapted to cooperate in a sliding manner with a fixed annular cam 44 during the displacement of relative operative unit 18 along path P.

Also in this case, cam 44 is arranged on the opposite side of electric motor 26 with respect to support element 21.

In particular, cam 44 is fixed to support structure 4, extends about axis A at the periphery of carousel 5 and cooperates, along a lower side thereof, with cam follower rollers 43 of actuator elements 31 of operative units 18. More precisely, cam 44 extends parallel to path P and has an operative portion 50 configured so as to determine the displacement of each actuator element 31 from the resting position to the operative position and vice versa. Operative portion 50 is placed in a predetermined angular position with reference to axis A, preferably along the arc of path P extending between transfer station 7, in which bottles 3 are fed to carousel 5, and transfer station 9, in which labels 2 are fed to bottles 3.

In the case shown in FIG. 5, operative portion 50 is defined by a notch of cam 44, which is placed at a distance from the plane of support elements 21 smaller than the distance from this plane of the remaining part of cam 44.

Cam follower roller 43 of each operative unit 18 is engaged in a sliding manner on a bracket 45 protruding on the lower side, by means of relative sleeve 36, from lower end 27b of relative stator 27 and extending parallel to relative axis E; a cylindrical helical spring 46 is wound about a lower end of relative bracket 45 and cooperates with relative cam follower roller 43 so as to load it elastically against cam 44.

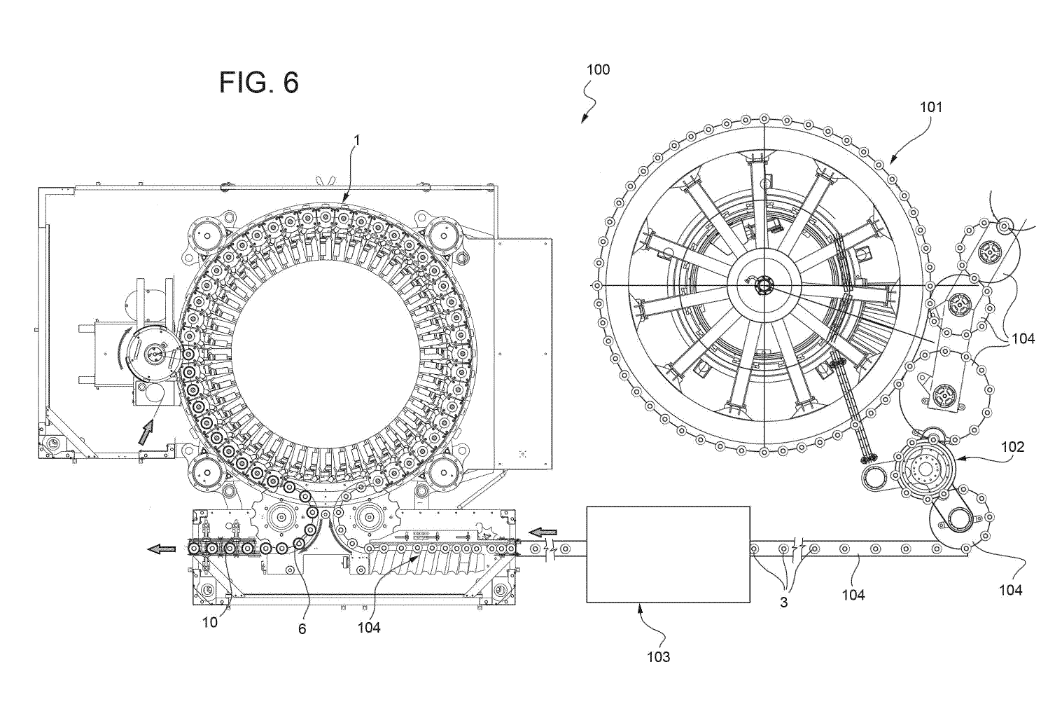

An example of a processing plant for bottles 3, indicated as a whole by numeral 100 and including labelling machine 1, is diagrammatically shown in FIG. 6.

In particular, system 100 comprises:
a filling machine 101 for filling bottles 3 with a hot pourable product;
a capping machine 102, arranged downstream of filling machine 101 and adapted to close bottles 3 with respective caps 17;
a cooling unit 103, arranged downstream of capping machine 102 and adapted to cool the product contained in closed bottles 3; and
a plurality of conveyors 104, of the star or linear type, for transferring bottles 3 within plant 100.

Labelling machine 1 is advantageously arranged immediately downstream of cooling unit 103 so that bottles 3 exiting this unit are transferred to labelling machine 1 only through linear or star conveyors 104, without intermediate process stations.

In practice, no processing is performed on bottles 3 during their transfer from cooling unit 103 to labelling machine 1.

In use, bottles 3 are filled on filling machine 101 with a hot pourable product, for example a liquid food product at about 85° C. In practice, empty bottles 3 are fed to filling machine 101 by an inlet conveyor 104, in the case shown a star conveyor, and after being filled, exit filling machine 101 through an outlet conveyor 104, also of the star type. From here bottles 3 reach capping machine 102, where they are closed with respective caps 17.

By the effect of the capping operation, heated air present in the top portion of each bottle 3, between the product and relative cap 17, expands causing a stress that tends to produce a general swelling of bottle 3. During this step, base portions 12 of bottles 3 are deformed assuming the first configuration shown in FIGS. 2 and 4.

It may be noted, also in the above said first deformed configuration, that central area 16 of base portion 12 does not project downwards beyond adjacent annular area 15; thereby, annular area 15 always ensures a stable support for relative bottle 3.

At this point, bottles 3 are fed to cooling unit 103 where the product contained therein is taken to the desired temperature. During this step, depressive stresses are generated within bottles 3 and tend to shrink them.

Bottles 3 exiting cooling unit 103 are fed, through a linear conveyor 104, directly to inlet wheel 6 and, from here, reach in a sequence the different operative units 18 of labelling machine 1.

In practice, each bottle 3 is arranged resting on support element 21 of a relative operating unit 18 within hollowed central area 23. Bottles 3 are fed to labelling machine 1 in a vertical position, with axes D thereof parallel to central axis A and coaxial to axes E of respective operating units 18.

During the movement of bottles 3 from transfer station 7 to transfer station 9, respective actuator elements 31 are activated to bring relative base portions 12 from the first to the second configuration and thus cancel the depressive stresses acting within bottles 3.

With particular reference to the solution shown in FIGS. 2 and 3, the displacement of actuator elements 31 is obtained by activating respective actuator assemblies 34. In practice, considering a single operative unit 18, the activation of relative actuator assembly 34 causes the displacement along axis E of relative actuator element 31 so that small rod 38 completely passes through opening 30 of relative support element 21. During this displacement, small rod 38 engages notch 39 of base portion 12 of bottle 3 arranged resting on relative support element 21 and pushes central area 16 of base portion 12 upwards until it is taken to the second configuration. At the end of this operation, actuator element 31 returns to its resting position (FIG. 2).

In the variant of FIGS. 4 and 5, the same displacement of actuator elements 31 is obtained through the interaction of cam follower rollers 43 with cam 44. In particular, the passage of cam follower roller 43 of a relative actuator element 31 at hollowed operative portion 50 of cam 44 determines a corresponding axial displacement upwards of actuator element 31, with the subsequent interaction of its small rod 38 with base portion 12 of relative bottle 3 to take it to the second configuration.

Once the deformation operation of base portions 12 is completed, bottles 3 reach labelling unit 8 to receive respective labels 2.

In order to obtain the winding of each label 2 on relative bottle 3, electric motor 26 of relative operative unit 18 is activated; thereby, relative support element 21 is rotated about its axis E with a corresponding rotation of bottle 3 borne thereby.

The fixing operation of labels 2 on respective bottles 3 is thus completed along the remaining portion of path P, until bottles 3 reach transfer station 11 where they are fed to outlet wheel 10.

From an analysis of the features of labelling machine 1 and of the relative processing plant 100 according to the present invention, the advantages it allows to obtain are apparent.

In particular, labelling machine 1, by means of a small modification of the structure of operative unit 18, allows to perform both the labelling operation of bottles 3, and the displacing operation of base portions 12 of bottles 3 from the first to the second configuration. This is obtained without modifying the path normally performed by operative units 18 on labelling machine 1 and without any intervention on the sequence of the operations traditionally performed to fix labels 2 on bottles 3.

Furthermore, the adoption of labelling machine 1 within a normal processing plant of bottles 3 allows to obtain, the same operations being performed, a reduction both of the number of machines employed and of the number of conveyors for transferring the above said bottles 3 from a machine to another. This also translates into a significant reduction of the overall space occupied by the processing plant with respect to the known plants.

Finally, it is clear that modifications and variants to labelling machine 1 and to processing plant 100 disclosed and shown herein can be made without departing from the scope of protection of the claims.

1. A labelling machine for applying labels on respective containers, said labelling machine comprising:
at least one operative unit adapted to receive a relative container to be labelled and provided with a support element for supporting a base portion of said container;
a conveyor device for transferring said operative unit along a predetermined path from a feeding station of said containers to an outlet station of the containers; and
feeding means for providing at least one label to be applied on the container borne by said operative unit;
wherein said operative unit further comprises motor means borne by said conveyor device on the opposite side of said support element with respect to the receiving position of said container and which can be selectively actuated to rotate said support element about an axis transversal to said path;
and wherein said support element has a through-opening coaxial to said axis; and wherein said operative unit also comprises an actuator element, mounted axially sliding within a through-hole of said motor means, and displacement means arranged on the opposite side of said motor means with respect to said support element for displacing said actuator element along said axis so as to act, through said opening, on said base portion of said container and displace it from a first deformed configuration, swollen towards said support element, to a second configuration, centrally retracted inwardly of the container.

2. The labelling machine of claim 1, wherein said actuator element is displaceable between a resting position, in which it is spaced from the base portion of the container borne by said support element, and an operative position, in which it engages the opening of said support element and cooperates with the base portion of said container.

3. The labelling machine of claim 1, wherein said displacing means comprise a fluidically driven actuator assembly.

4. The labelling machine of claim 1, wherein said displacement means comprise a fixed cam and a cam follower roller integral with said actuator element and cooperating in a sliding manner with said cam during the displacement of said operative unit along said path.

5. The labelling machine of claim 4, wherein said cam extends parallel to said path and has an operative portion configured so as to determine the displacement of said actuator element from said resting position to said operative position and vice versa.

6. The labelling machine of claim 1, wherein said motor means comprise a stator which is fixed to said conveyor device, and a hollow rotating member which is supported by said stator in a rotating manner about said axis, is fixed to said support element and through which said actuator element axially slides.

7. The labelling machine of claim 1, wherein said support element has a hollowed receiving seat of the base portion of a relative container.

8. The labelling machine of claim 1, wherein said operative unit also comprises sensor means generating a signal correlated to the displacement along said axis of said actuator element to bring the base portion of the relative container from the first to the second configuration.

9. The labelling machine of claim 1, wherein said operative unit is configured to receive hot fill containers, which are closed and cooled.

10. The labelling machine of claim 1, comprising a plurality of said operative units angularly equally spaced from one another about an axis parallel to axes of the operative units.

11. A plant for processing containers comprising:
a filling machine for filling said containers with a hot pourable product;
a capping machine arranged downstream of said filling machine and adapted to close said containers with respective closing devices;
a cooling unit arranged downstream of said capping machine and adapted to cool the product contained in said closed containers;
a labelling machine as claimed in claim 1; and
transfer means of said containers from said cooling unit to said labelling machine without intermediate process stations.
